(19) United States
(12) Patent Application Publication
(10) Pub. No.: US 2026/0012049 A1
(43) Pub. Date: Jan. 8, 2026

(54) MOTOR INCLUDING A COOLING STRUCTURE

(71) Applicants: HYUNDAI MOTOR COMPANY, Seoul (KR); KIA CORPORATION, Seoul (KR)

(72) Inventors: Jae Joon Lee, Hwaseong-si (KR); Dang Hee Park, Hwaseong-si (KR); Kwon Su Shin, Hwaseong-si (KR); Jeong Uk An, Hwaseong-si (KR); Ki Tack Lim, Hwaseong-si (KR); Yong Sok Jang, Hwaseong-si (KR); Kyung Ku Yeo, Hwaseong-si (KR); Chee Mann Kim, Hwaseong-si (KR); Kyung Jun Lee, Hwaseong-si (KR); Kam Chun Lee, Hwaseong-si (KR); Sung Ho Lee, Hwaseong-si (KR); Hoan Ju Yoo, Hwaseong-si (KR); Dong Su Lee, Hwaseong-si (KR); Yun kyung Hwang, Hwaseong-si (KR); Hong Wook Lee, Hwaseong-si (KR); Jae Young Jeun, Hwaseong-si (KR)

(73) Assignees: HYUNDAI MOTOR COMPANY, Seoul (KR); KIA CORPORATION, Seoul (KR)

(21) Appl. No.: 18/959,156

(22) Filed: Nov. 25, 2024

(30) Foreign Application Priority Data
Jul. 8, 2024 (KR) 10-2024-0089631

(51) Int. Cl. H02K 1/20

(52) U.S. Cl. CPC H02K 1/20; H02K 2201/03

(57) ABSTRACT

A motor including a cooling structure configured to directly cool a coil of a stator of the motor. The stator includes a stator core and a coil. The stator core may include a plurality of teeth configured to have the coil wound thereon, a plurality of slots partitioned by the teeth, and a flow path configured to communicate with the slots from the outer circumference of the stator core through the stator core and allow oil to be supplied therethrough.

### CROSS REFERENCE TO RELATED APPLICATION

The present application claims priority to Korean Patent Application No. 10-2024-0089631, filed on Jul. 8, 2024, the entire contents of which are incorporated herein by reference.

### BACKGROUND

### Technical Field

The present disclosure relates to a motor and, more particularly, to a motor including a cooling structure.

### Description of the Related Art

The motor receives electrical energy to generate rotational force. Recently, research and development on motors that drive vehicles instead of engines are actively being conducted.

A motor includes a stator and a rotor. The rotor may rotate relative to the stator by the electromagnetic interaction between the stator and the rotor. For example, the stator may have a coil wound thereon, and the rotor may have a coil wound thereon or permanent magnets mounted therein. When the coil of the stator is magnetized with the current applied thereto, the rotor may rotate through interaction with the coil or permanent magnets of the rotor.

Since a large amount of heat is generated by the current applied to the coil during the operation of the motor, the motor is equipped with a cooling structure for its stable operation.

In general, the cooling structure of the motor utilizes a refrigerant to indirectly cool the motor or to remove the heat of the coil exposed to the outside. Such a structure is incapable of directly cooling the heat generated by the coil inside the stator, which limits its cooling performance.

The foregoing is intended merely to aid in the understanding of the background of the present disclosure, and may not constitute prior art that is already known to one having ordinary skill in the art.

### SUMMARY

The present disclosure has been made keeping in mind the above problems occurring in the related art, the present disclosure provides a motor capable of effectively removing the heat generated by a stator through direct cooling.

The present disclosure provides a motor capable of improving the continuous output and efficiency of the motor through a cooling structure.

The present disclosure is intended to enable the miniaturization of the motor through the cooling structure.

Objectives of the present disclosure are not limited to the objectives mentioned above, and other objectives not mentioned above may be clearly understood by one having ordinary skill in the art from the description below.

In order to achieve the objectives of the present disclosure as described above and perform the characteristic functions of the present disclosure to be described below, the present disclosure may be featured as follows.

According to some forms of the present disclosure, a stator may include a stator core and a coil. The stator core includes: teeth configured to have the coil wound thereon, a plurality of slots partitioned by the teeth, and a flow path configured to communicate with the slots from an outer circumference of the stator core through the stator core and allow oil to be supplied therethrough.

According to some forms of the present disclosure, a cooling system for a motor may include: the stator; an oil chamber disposed at a lower portion of the stator; a pump configured to direct the oil from the oil chamber into the flow path of the stator; and a heat exchanger arranged to exchange heat with the oil.

According to some forms of the present disclosure, a motor may include: the stator including the stator core and the coil; and a rotor configured to be rotatable relative to the stator. The stator core may include: the plurality of teeth configured to have the coil wound thereon; the plurality of slots partitioned by the teeth; and the flow path configured to communicate with the slots from the outer circumference of the stator core through the stator core and allow the oil to be supplied therethrough.

According to some embodiments of the present disclosure, a vehicle may include the motor.

As described above, according to the present disclosure, a motor capable of effectively removing the heat generated by a stator through direct cooling may be provided.

According to the present disclosure, a motor capable of improving the continuous output and efficiency of the motor by a cooling structure may be provided.

According to the present disclosure, a motor enabling miniaturization of a motor through a cooling structure may be provided.

The effects of the present disclosure are not limited to those described above, and other effects not mentioned may be clearly recognized by those having ordinary skill in the art from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view showing a motor in an embodiment of the present disclosure;

FIG. 2 is a view partially showing a cross-section of a stator core of a motor in an embodiment of the present disclosure;

FIG. 3 is a view partially showing a cross-section of a stator of a motor according to an embodiment of the present disclosure;

FIG. 4 is a view showing a cooling system of the motor according to an embodiment of the present disclosure;

FIGS. 5 and 6 are perspective views showing a portion of the stator according to an embodiment of the present disclosure;

FIG. 7A is a sectional view along the line A1-A1 in FIG. 6;

FIG. 7B is a sectional view along the line A2-A2 in FIG. 6;

FIG. 8A is a sectional view showing a portion of the stator according to an embodiment of the present disclosure and showing flows of oil;

FIG. 8B is a perspective view showing a portion of the stator according to an embodiment of the present disclosure and showing the flows of oil;

FIG. 9A is a perspective view showing a portion of the stator according to an embodiment of the present disclosure;

FIGS. 9B and 9C are views showing the flows of oil through a flow path shown in FIG. 9A;

FIG. 10 is a sectional view showing a portion of the stator according to an embodiment of the present disclosure;

FIG. 11A is a sectional view along the line B1-B1 in FIG. 10;

FIG. 11B is a sectional view along the line B2-B2 in FIG. 10;

FIG. 11C is a sectional view along the line B3-B3 in FIG. 10;

FIG. 11D is a sectional view along the line B4-B4 in FIG. 10;

FIG. 12A is a perspective view showing a portion of the stator according to an embodiment of the present disclosure and the oil flow through the flow path;

FIG. 12B is a sectional view showing a portion of the stator according to an embodiment of the present disclosure;

FIG. 13A is a sectional view along the line C1-C1 in FIG. 12B;

FIG. 13B is a sectional view along the line C2-C2 in FIG. 12B;

FIG. 13C is a sectional view along the line C3-C3 in FIG. 12B;

FIG. 14A is a perspective view showing a portion of the stator according to an embodiment of the present disclosure and the oil flow through the flow path;

FIG. 14B is a sectional view of a portion of a stator according to an embodiment of the present disclosure,

FIG. 15A is a sectional view along the line D1-D1 in FIG. 14B;

FIG. 15B is a sectional view along the line D2-D2 in FIG. 14B;

FIG. 15C is a sectional view along the line D3-D3 in FIG. 14B;

FIG. 16A is a perspective view showing a portion of the stator according to an embodiment of the present disclosure and the oil flow through the flow path;

FIG. 16B is a sectional view showing a portion of the stator according to an embodiment of the present disclosure;

FIG. 17A is a sectional view along the line E1-E1 in FIG. 16B;

FIG. 17B is a sectional view along the line E2-E2 in FIG. 16B;

FIG. 17C is a sectional view along the line E3-E3 in FIG. 16B;

FIG. 18A is a view showing a motor including a housing according to an embodiment of the present disclosure;

FIG. 18B is a view showing a flow path provided between the housing of FIG. 18A and a stator core;

FIG. 19A is a view showing a slot portion of the stator according to an embodiment of the present disclosure;

FIG. 19B is a perspective view showing a portion of the stator according to an embodiment of the present disclosure;

FIGS. 20A and 20B are views showing a slot portion of the stator according to an embodiment of the present disclosure;

FIG. 21A is a view showing a slot portion of the stator according to an embodiment of the present disclosure;

FIG. 21B is a perspective view showing a portion of the stator according to an embodiment of the present disclosure; and

FIGS. 22A, 22B, and 22C are views showing slot portions of the stators in various embodiments of the present disclosure.

### DETAILED DESCRIPTION

Specific structural and functional descriptions described in the embodiments of the present disclosure are exemplified merely for the purpose of explaining the embodiments according to a concept of the present disclosure, and the embodiments according to the concept of the present disclosure may be implemented in various forms. In addition, the present disclosure should not be construed to be limited by the embodiments described in the present disclosure and should be understood to include all modifications, equivalents, or substitutes included in the spirit and technical scope thereof.

In the present disclosure, terms such as “first” and “second” may be used to describe various components, but the components are not limited by the terms. The above terms are used only for the purpose of distinguishing one component from other components, and for example, within a range not departing from the scope of rights according to the concept of the present disclosure, a first component may be referred to as a second component, and similarly, the second component may also be referred to as the first component.

When a component, device, element, or the like of the present disclosure is described as having a purpose or performing an operation, function, or the like, the component, device, or element should be considered herein as being “configured to” meet that purpose or to perform that operation or function.

It should be understood that when a component is referred to as being “coupled” or “connected” to another component, it may be directly coupled or connected to another component, but other components may even exist in the middle. On the other hand, when a component is referred to as being “directly coupled” or “directly connected” to another component, it should be understood that no other component exists in the middle. Other expressions used to describe the relationship between each component, such as “between” and “directly between” or “adjacent to” and “directly adjacent to,” should be interpreted similarly.

Like reference numbers indicate like elements throughout the present specification. Meanwhile, terms used in the present disclosure are for describing the embodiments and are not intended to limit the present disclosure. In the present specification, a singular form also includes a plural form unless specifically stated in a phrase. As used herein, “comprises” and/or “comprising” implies that a stated component, step, operation, and/or element does not rule out the presence or addition of one or more other components, steps, operations, and/or elements.

Hereinbelow, the present disclosure is described in detail with reference to the accompanying drawings.

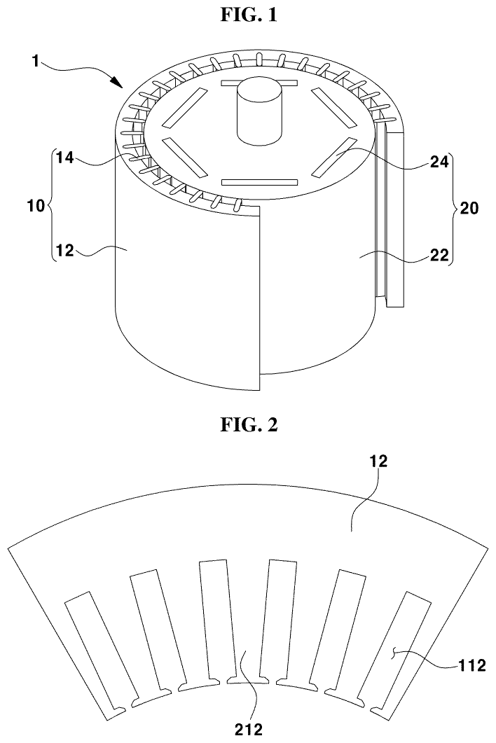

As shown in FIG. 1, according to an embodiment of the present disclosure, a motor 1 includes a stator 10 and a rotor 20. The rotor 20 may be arranged inside the stator 10. The rotor 20 is configured to be rotatable relative to the stator 10. The rotor 20 may rotate relative to the stator 10 by electromagnetic interaction between the stator 10 and the rotor 20.

The stator 10 includes a stator core 12 and a coil 14. A coil 14, to which current is applicable, is wound on the stator core 12. The rotor 20 includes a rotor core 22 and a permanent magnet 24. The permanent magnet 24 may be mounted on the rotor core 22. In the illustrated embodiment, a permanent magnet 24 is depicted on the rotor 20, but an electromagnet may also be used.

As shown in FIG. 2, the stator core 12 is provided with slots 112 therein. Specifically, teeth 212 are provided along the circumferential direction of the stator core 12. The slots 112 may be defined by the teeth 212. The slots 112 may be spaced apart from one another at a preset interval along the circumferential direction of the stator core 12.

In a conventional cooling structure of the motor, the stator windings are cooled indirectly by an outer flow path or by contact with the refrigerant at the outside of the stator, which causes a limitation in cooling the stator core windings, which are the main heat-generating component of the motor. Moreover, as the motor is designed to have high speed, the alternating current (AC) loss increases. In particular, it is well known that the AC loss is the highest in windings at an air gap side of the motor, close to the rotor magnets. Conventional cooling structures have not been able to efficiently remove generated heat that is particularly significant in the windings on the air gap side, which has greatly limited the continuous output of high-speed motors.

The present disclosure provides a cooling system for a motor including a cooling path that directly supplies cooling oil to a coil, thereby directly cooling the core and air gap-side windings of a stator.

As shown in FIG. 3, according to an embodiment of the present disclosure, the stator core 12 includes a flow path 100. The flow path 100 may extend through the interior of the stator core 12. In one embodiment, the flow path 100 may extend in an approximately radial direction of the stator core 12.

According to an embodiment of the present disclosure, the flow path 100 may be in fluid communication with the slots 112. In one embodiment, the flow path 100 may communicate with the slots 112 through a supply flow path 110, an extension flow path 120, and a connection flow path 130. Each of the slots 112 may be provided with an axial flow path 140 extending along the axial direction of the stator core 12.

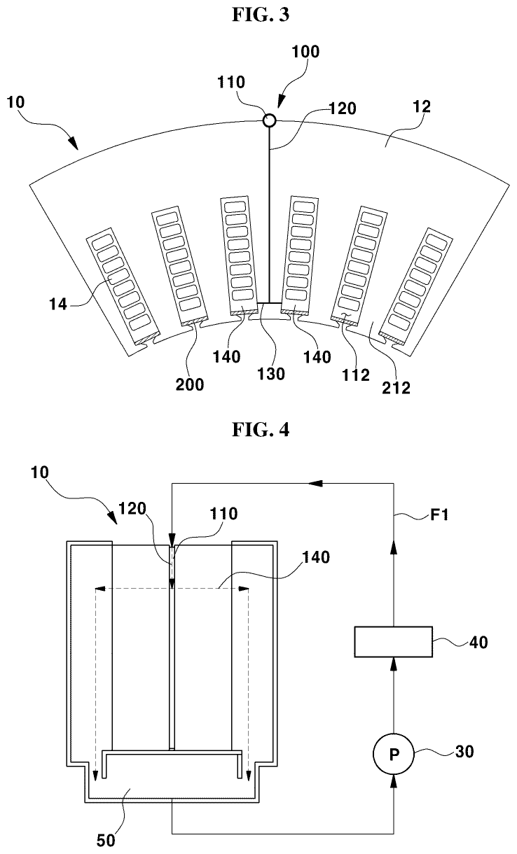

With reference to FIG. 4, the flow path 100 may allow oil to flow therethrough. The oil may cool the motor 1, flowing through the stator 10. Specifically, the oil may be circulated by a pump 30 and may flow along a flow direction F1. After completing heat exchange with a heat exchanger 40, the oil may be supplied to the flow path 100 of the stator 10. The oil that has completed cooling of the stator 10 is collected, by gravity, in a chamber 50 located at the bottom of the stator 10. The oil collected in the chamber 50 may be recirculated by the pump 30.

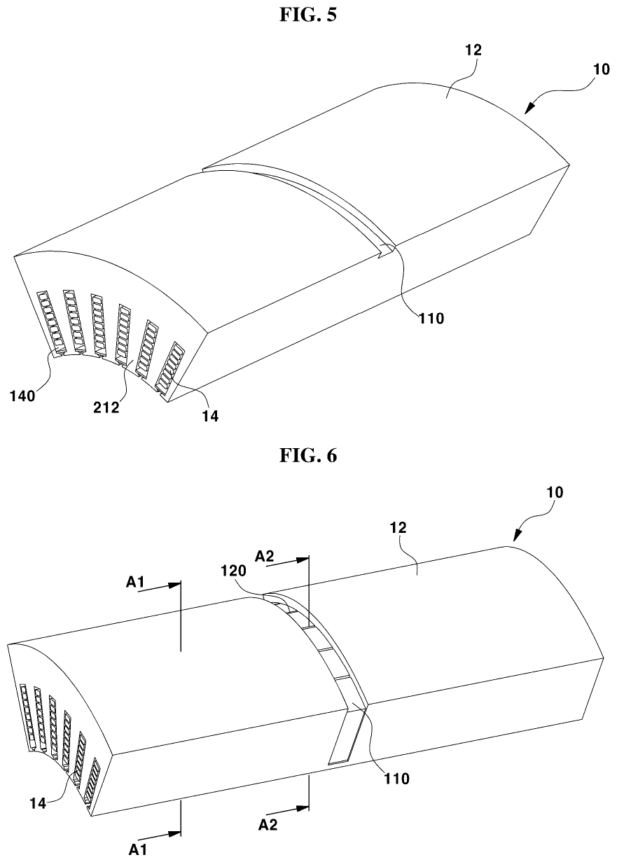

As shown in FIGS. 5 and 6, the supply flow path 110 may extend in the circumferential direction of the stator core 12. In one embodiment, the supply flow path 110 may be recessed into the stator core 12. The oil supplied to the supply flow path 110 may flow through the extension flow path 120. The extension flow path 120 may extend along the interior of the stator core 12. The oil flowing along the extension flow path 120 may be supplied to the axial flow path 140 to directly cool the coil 14.

According to one embodiment of the present disclosure, the supply flow path 110 at the stator core 12 may be disposed at a central portion of the axial length of the stator core 12. The supply flow path 110 may thereby allow the oil to uniformly flow through the axial flow path 140 to opposite sides with respect to the supply flow path 110. However, the supply flow path 110 may also be disposed at another portion of the stator core 12.

In one embodiment, the stator core 12 is a laminated core manufactured by laminating (e.g., stacking) a plurality of electrical steel plates. In one embodiment, the stator core 12 may be manufactured by laminating at least two steel plates with different shapes. According to the present disclosure, since the flow path 100 is formed by laminating at least two steel plates having different shapes, an additional structure for creating the flow path 100 may be omitted. With this configuration, a larger cooling area is secured and loss in electromagnetic performance is reduced.

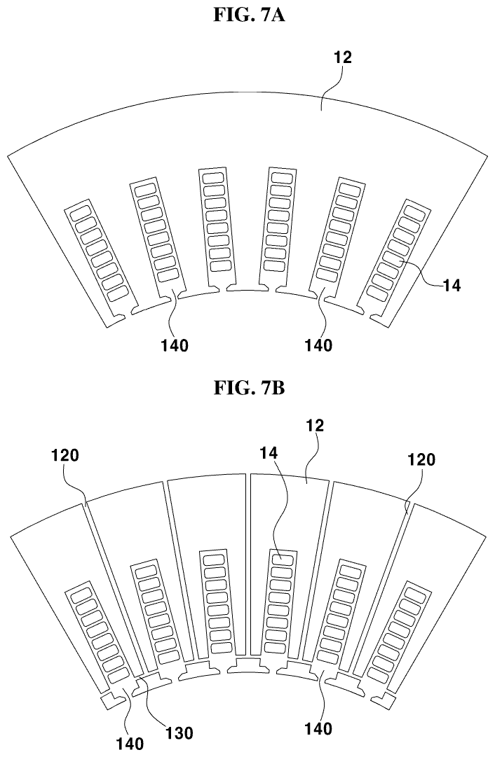

With reference to FIGS. 7A and 7B, in one embodiment, a portion of the stator core 12, excluding the supply flow path 110, may be constructed from a single steel plate, as shown in FIG. 7A. In addition, in a portion of the stator, including the supply flow path 110, the flow path 100 may be formed by separated steel plates, as depicted in FIG. 7B.

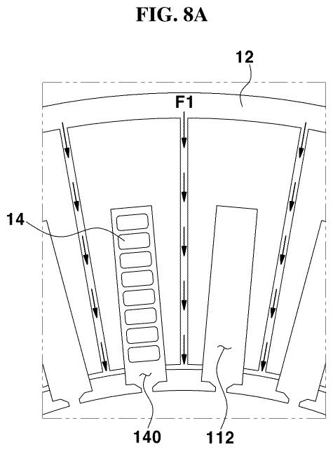

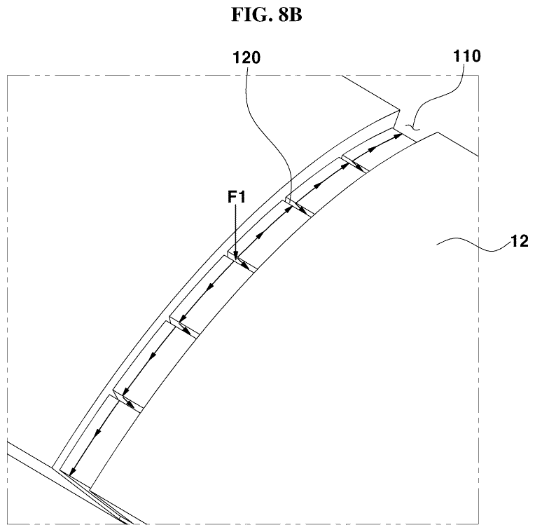

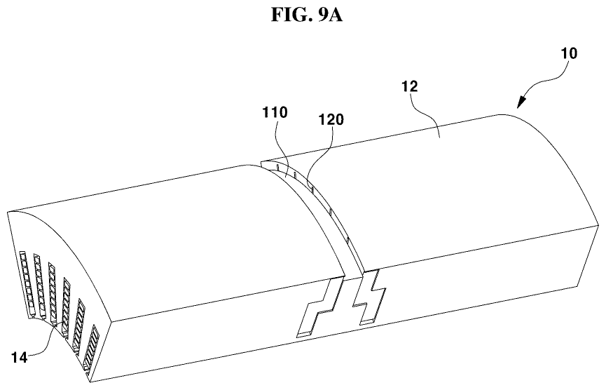

Through such a structure, the oil is supplied to the stator core 12 through the supply flow path 110, as shown in FIGS. 8A and 8B. The oil may be then directed to the axial flow path 140 in the slot 112 by sequentially passing through the extension flow path 120 and the connection flow path 130 along the flow direction F1.

In one embodiment, the flow path 100 may be formed by laminating steel plates having various shapes other than in the illustrated example of FIG. 6.

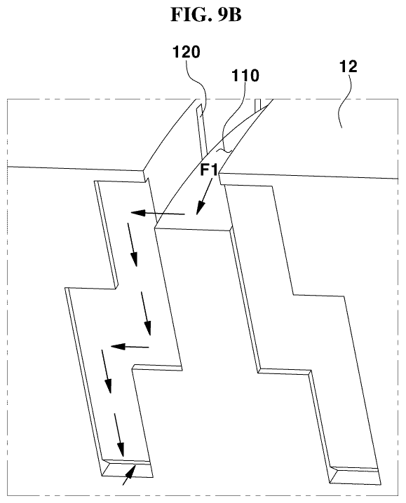

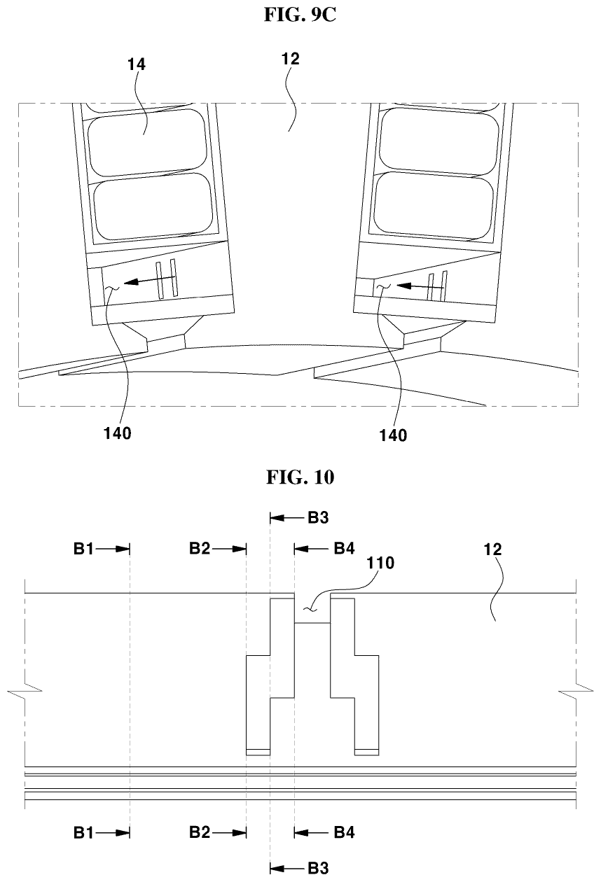

As shown in FIGS. 9A and 9B, the supply flow path 110 may have a step-shaped path. The oil flowing through the flow path 100 having the step-shaped path may be supplied to the axial flow path 140 within the slot 112 through the connection flow path 130 (see FIG. 9C).

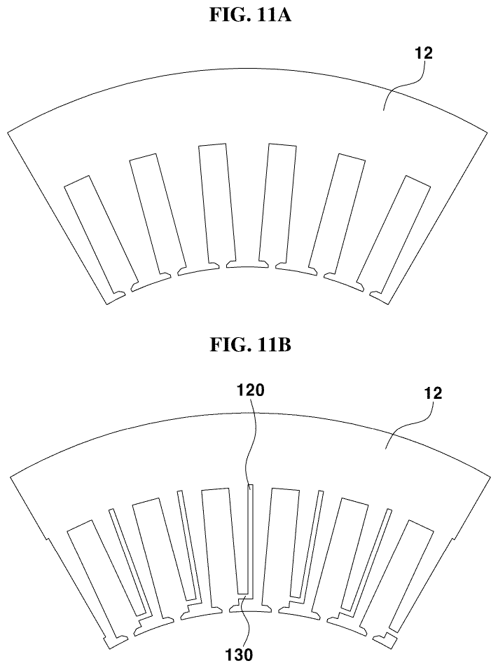

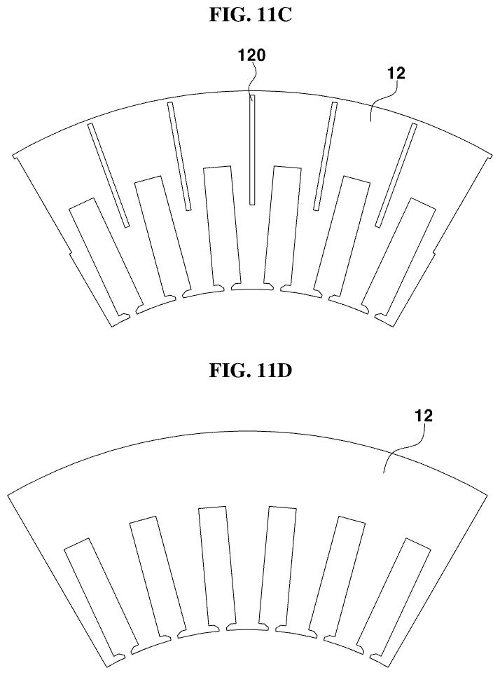

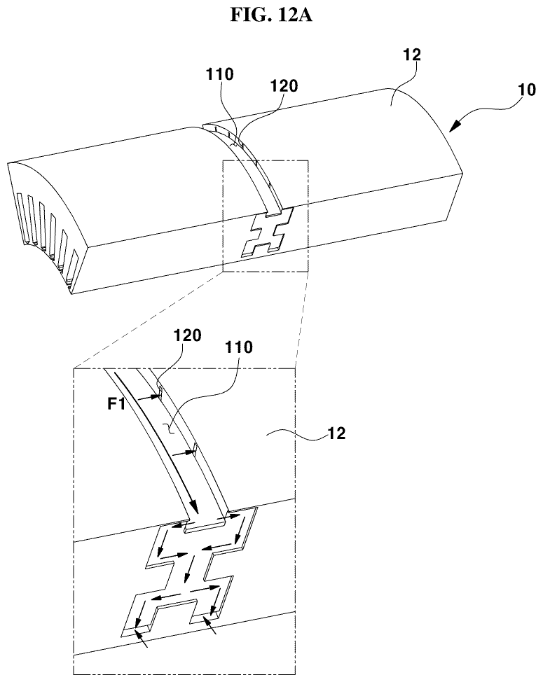

Such a structure may improve the manufacturability of the stator core 12. As shown in FIG. 10, the stator core 12 may be divided into sections, and a portion without the flow path 100 on the surface of the stator core 12 may be provided as shown in FIGS. 11A and 11D. The portion of the stator core 12 constituting the flow path 100 on the surface of the stator core 12 may be formed using steel plates with cross-sections of shapes that differ from one another (see FIGS. 11B and 11C). In particular, the flow path 100 provided in the steel plate that directly contacts the steel plate containing the portion without the flow path 100 is configured to have an L-shape. This may enhance the case of steel plate manufacturing by preventing the occurrence of independent pieces and may minimize the deterioration of electromagnetic performance.

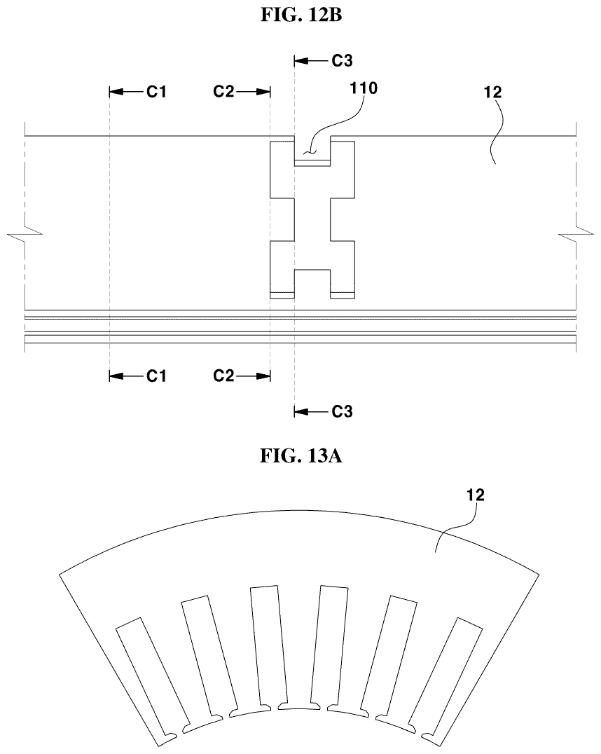

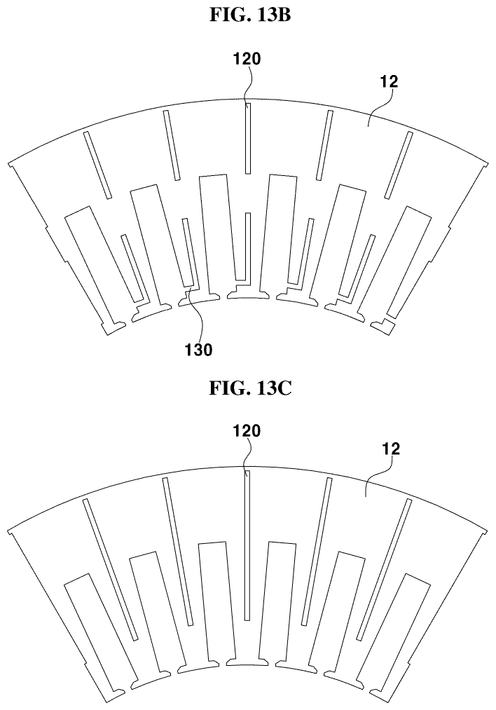

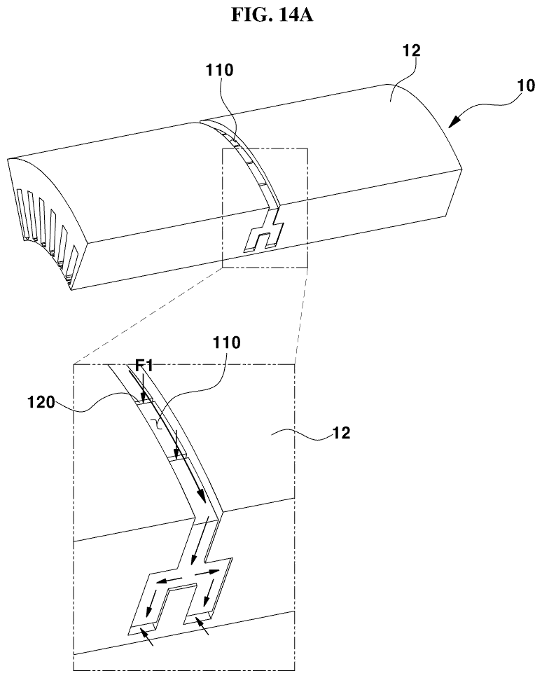

As shown in FIGS. 12A and 12B, the supply flow path 110 may have an H shape which may limit the types of steel plates required to three to reduce the production process and cost. For example, the flow path 100 may be provided using the three shapes of steel plates shown in FIGS. 13A to 13C. By minimizing the types of steel plates, the increase in molds due to the diversification of steel plates may be minimized and the number of processes may be reduced. In addition, since the lamination of a base steel plate may be increased, the deterioration of electromagnetic performance may be reduced or minimized.

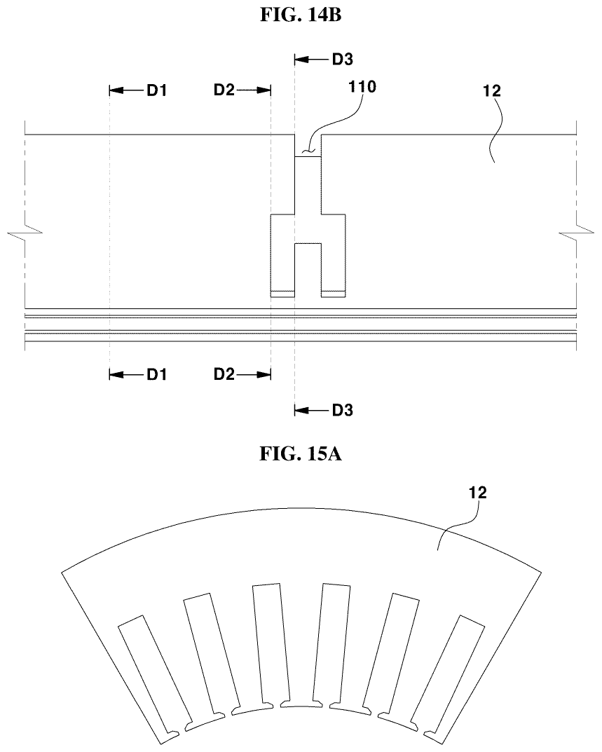

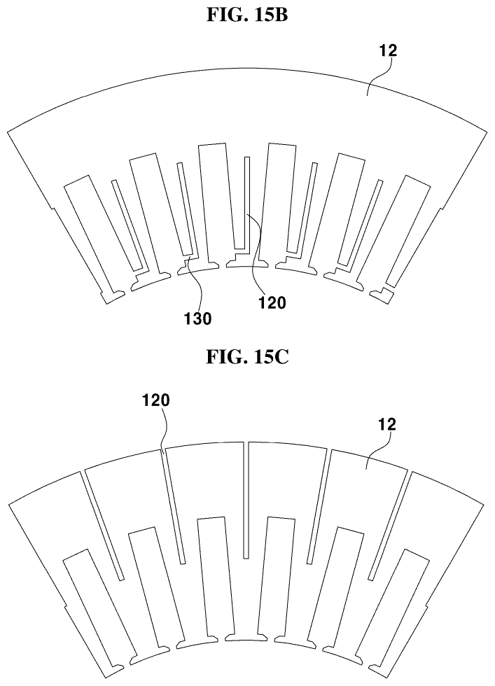

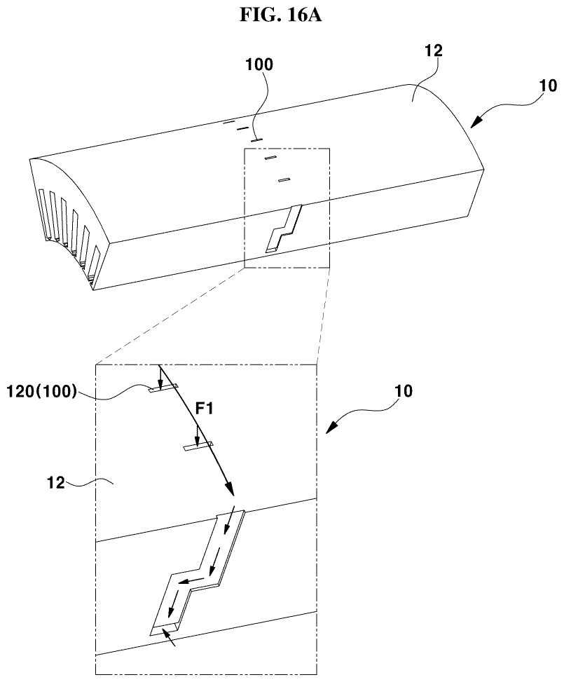

As shown in FIGS. 14A and 14B, the supply flow path 110 may take a Y shape. This shape of the flow path 100 may reduce the types of steel plates required to three, thereby simplifying the production process and reducing costs. Additionally, since the shape of each steel plate is simple, manufacturing may be easy. For example, the flow path 100 may be formed through three shapes of steel plates shown in FIGS. 15A to 15C. The number of molds and processes may be reduced by minimizing the types of steel plates. Also, since the shape of each steel plate may be simplified, the case of manufacturing may be improved. In addition, from a performance perspective, since the number of layers of the base steel plate may be increased, the deterioration of electromagnetic performance may be reduced or minimized.

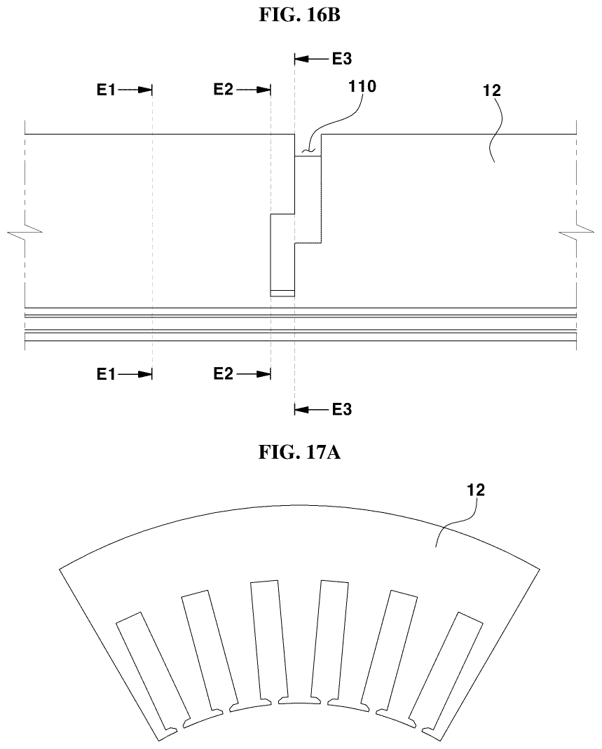

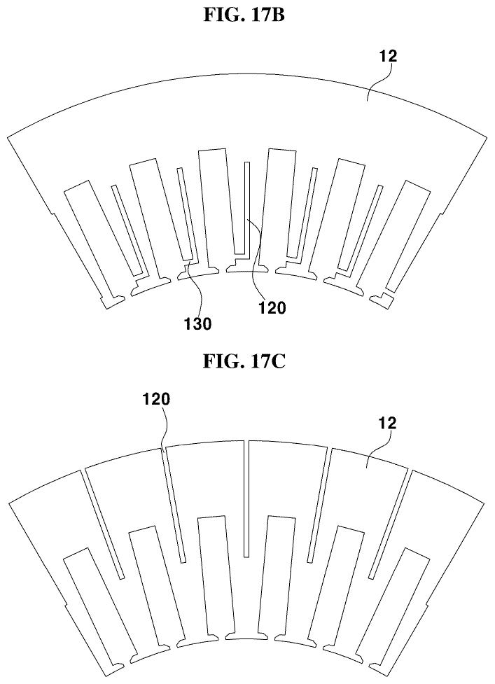

As shown in FIGS. 16A and 16B, the supply flow path 110 may take an N shape, which may reduce the required types of steel plates to three, thereby simplifying the production process and reducing costs. In addition, since the lamination of the electrical steel plates used in the flow path 100 is reduced, the electromagnetic performance may be minimized. For example, the flow path 100 may be provided with three shapes of steel plates shown in FIGS. 17A to 17C. The number of molds and processes may be reduced by minimizing the types of steel plates. In addition, since the shape of each steel plate may be simplified, the case of manufacturing may be improved. Moreover, from a performance perspective, the number of layers of the base steel plate (for instance, electrical steel plate having a cross-section as shown in FIG. 17A) that serves as the basis for the stator core 12 may be increased so that the deterioration of electromagnetic performance may be reduced or minimized.

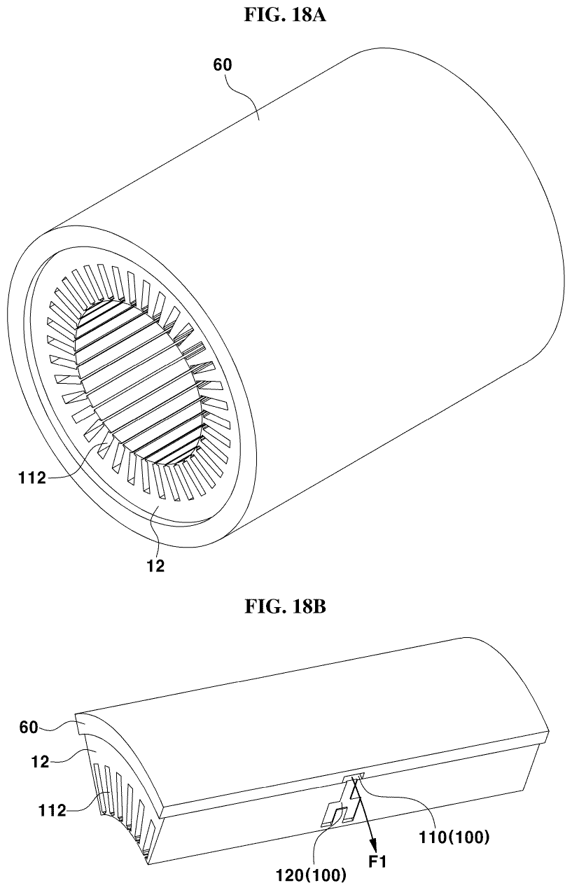

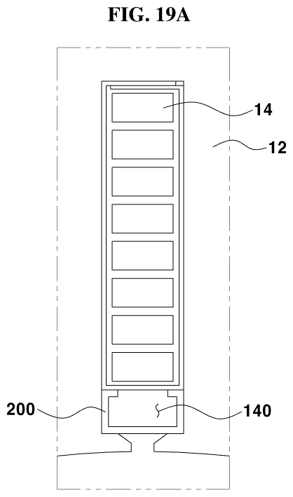

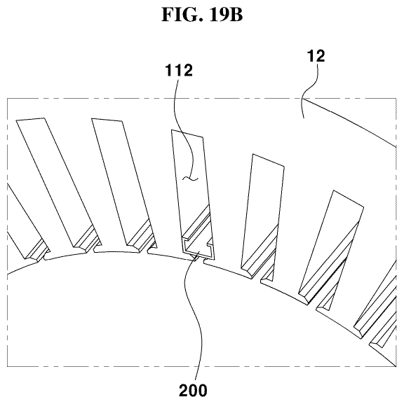

With reference to FIG. 18A, the cooling structure of the motor according to the present disclosure may include a housing 60. The flow path, i.e., the supply flow path 110, which flows along the outer circumference of the stator 10 to distribute oil to each slot 112 of the stator core 12 is included. As shown in FIG. 18B, according to one embodiment of the present disclosure, the supply flow path 110 may be defined by the housing 60 and the stator core 12. The oil may flow through the supply flow path 110 recessed into the housing 60.

In one embodiment, the housing 60 may be press-fitted into the stator core 12. This may improve the manufacturability, such as tolerance management and the like, by maintaining the outer diameter of the steel plates constituting the stator core 12 constant. Additionally, the influence on the electromagnetic performance of the motor 1 including the supply flow path 110 may also be reduced.

As shown in FIGS. 19A and 19B, according to the present disclosure, the cooling structure of the motor may include a gutter 200. The gutter 200 may prevent oil leakage due to the opening of the slot 112. In other words, the gutter 200 may prevent oil from flowing into an air gap between the stator 10 and the rotor 20, thereby reducing or minimizing drag loss caused by the oil.

As shown in FIG. 19B, the gutter 200 may be inserted and placed within the slot 112. In some embodiments, the gutter 200 may be disposed inside at least one slot 112 or within each of the plurality of slots to retain the oil inside the slot(s). The upper part of the gutter 200 is open, allowing the oil and the coil 14 to come into direct contact, which may maximize the cooling effect. When oil leaks to the gap, it may cause resistance to the rotation of the motor, resulting in problems, such as power loss and heat generation. However, according to the present disclosure, the above-mentioned issues may be addressed by incorporating the gutter 200.

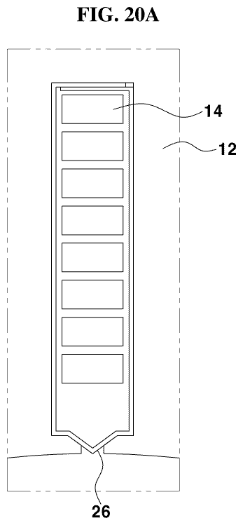

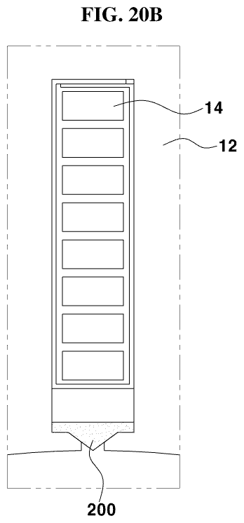

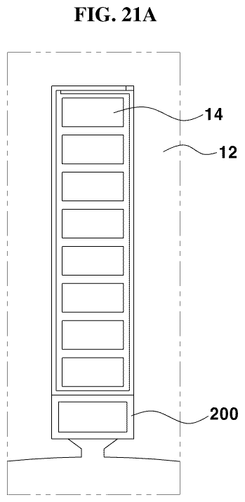

According to an embodiment of the present disclosure, the gutter 200 may include insulating paper 26. As shown in FIG. 20A, the oil leaks may be avoided or prevented by folding the insulating paper 26 surrounding the outside of the coil 14. This structure may prevent the oil from leaking into the axial flow path 140 without inserting an additional structure. Since the insulating paper 26 used in the motor 1 is mostly made from thinly processed plastic material, it may effectively serve as a structure through which liquid flows. In one embodiment, the insulating paper 26 is manufactured larger than the coil 14 so that the space at a lower portion of the slot 112 may be used as the axial flow path 140.

As shown in FIG. 20B, according to some embodiments of the present disclosure, the gutter 200 may be a separate structure. When the gutter 200 is the separate structure, it may be attached by manufacturing it a shape that corresponds to the shape of the opening in the slot 112. This may provide a structure that prevents oil leak, regardless of the opening shape of the slot 112. In one example, the gutter 200 may be made of a non-magnetic material, such as plastic.

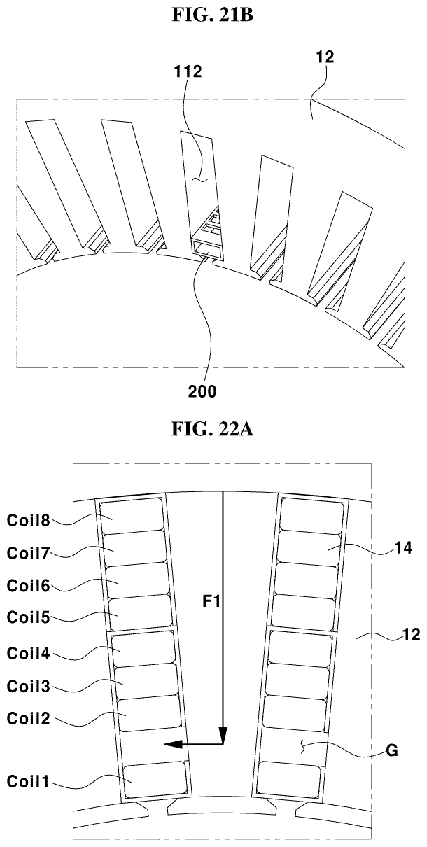

As shown in FIG. 21A, in one embodiment, the gutter 200 may be a separate structure. Such a gutter 200 may secure the coil 14 at the upper portion of the gutter 200, function as the flow path 100, and prevent the oil leak. As in the shown embodiment, a plurality of holes may be formed at the top of the gutter 200.

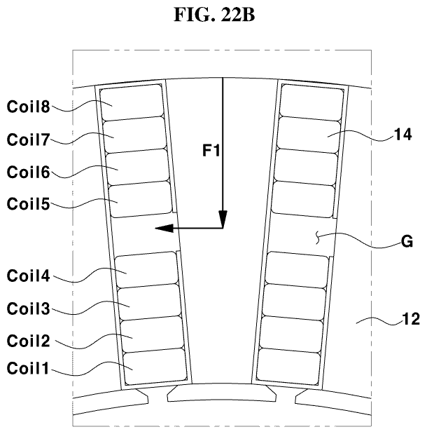

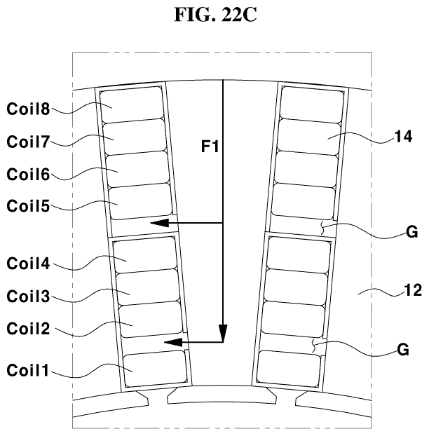

As shown in FIGS. 22A, 22B, and 22C, a gap G may be provided between windings of the coil 14. During design of the stator 10, the gap G may be formed between the windings of the coil 14, and the gap G may function as the axial flow path 140. As in the illustrated embodiment, the insulating paper 26 and the coil 14 are tightly fitted within the slot 112. Given that, not only may oil leak may be prevented, but also the flow path 100 is created at a desired location, thereby improving cooling capability.

The cooling structure of the motor according to the present disclosure may effectively remove the heat generated in a deep part and air gap-side windings of the motor, which was insufficient in conventional cooling systems.

The cooling structure of the motor according to the present disclosure provides a cooling path that may directly cool the lower part of the coil in order to remove the heat concentrated on the coil near the air gap of the motor. The cooling performance on the coil and the deep part of the stator steel plates may be improved through the axial flow path that directly pass through the slot. As a result, continuous output may be also improved with improved cooling performance. In addition, power efficiency may be also improved because temperature rise in the coil may be prevented.

Also, the cooling structure of the motor according to the present disclosure may enhance the efficiency of the motor. Since the resistance of the coil is proportional to the temperature, the temperature of the coil may be lowered through the direct cooling of the coil of the present disclosure, thereby maintaining the resistance low. According to Ohm's law, low resistance reduces copper loss and may ultimately improve the efficiency of the motor.

The cooling structure of the motor according to the present disclosure enables slimming of the motor. According to the present disclosure, it may be possible to implement a compact room for electrical components in a vehicle, improve aerodynamics and fuel efficiency by lowering a hood of a vehicle, move seatings of a vehicle forward, increase the interior space of a vehicle, reduce an overhang caused by a mounting angle of the electrical components, and increase the cargo space of a cargo vehicle.

The present disclosure described above is not limited to the above-described embodiments and the accompanying drawings, and it will be obvious to one having ordinary skill in the art that various substitutions, modifications, and changes are possible without departing from the technical spirit of the present disclosure.

What is claimed is:

1. A stator comprising:
a stator core; and
a coil,
wherein the stator core includes:
teeth, wherein the coil is wound around the teeth;
a plurality of slots partitioned by the teeth; and
a flow path configured to communicate with the plurality of slots from an outer circumference of the stator core through the stator core and allow oil to be supplied therethrough.

2. The stator of claim 1, wherein the flow path comprises:
a supply flow path formed, along a circumferential direction, on the outer circumference of the stator core.

3. The stator of claim 2, wherein the flow path further comprises:
an extension flow path extending from the supply flow path in a radially inward direction of the stator core.

4. The stator of claim 3, wherein the flow path further comprises:
an axial flow path configured to communicate with the extension flow path and arranged inside the plurality of slots.

5. The stator of claim 4, further comprising:
a connection flow path configured to connect the extension flow path and the axial flow path.

6. The stator of claim 1, further comprising:
a gutter disposed inside at least one slot of the plurality of slots and configured to retain the oil inside the at least one slot.

7. The stator of claim 6, wherein the gutter is an insulating paper configured to wrap the coil.

8. The stator of claim 6, wherein the gutter comprises:
a plurality of holes formed in an upper portion of the gutter.

9. The stator of claim 1, wherein the stator core is a laminated core in which a plurality of electrical steel plates is laminated, and
the flow path is formed by at least two electrical steel plates having different sectional shapes among the plurality of the electrical steel plates.

10. A cooling system for a motor, the cooling system comprising:
a stator;
an oil chamber disposed at a lower portion of the stator;
a pump configured to direct oil in the oil chamber toward a flow path of the stator; and
a heat exchanger configured to exchange heat with the oil,
wherein the stator includes:
a stator core; and
a coil,
wherein the stator core includes:
teeth, wherein the coil is wound around the teeth;
a plurality of slots partitioned by the teeth; and
a flow path configured to communicate with the plurality of slots from an outer circumference of the stator core through the stator core and allow oil to be supplied therethrough.

11. A motor comprising:
a stator including a stator core and a coil; and
a rotor configured to be rotatable relative to the stator,
wherein the stator core includes:
teeth, wherein the coil is wound around the teeth;
a plurality of slots partitioned by the teeth; and
a flow path configured to communicate with the plurality of slots from an outer circumference of the stator core through the stator core and allow oil to be supplied therethrough.

12. The motor of claim 11, wherein the flow path comprises:
a supply flow path formed, along a circumferential direction, on the outer circumference of the stator core.

13. The motor of claim 12, wherein the flow path further comprises:
an extension flow path extending from the supply flow path in a radially inward direction of the stator core.

14. The motor of claim 13, wherein the flow path further comprises:
an axial flow path configured to communicate with the extension flow path and arranged inside the plurality of slots.

15. The motor of claim 14, further comprising:
an air gap provided between the stator and the rotor,
wherein the axial flow path is formed near the air gap.

16. The motor of claim 11, further comprising:
a gutter arranged inside at least one slot of the plurality of slots and configured to retain the oil inside the at least one slot.

17. The motor of claim 16, wherein the gutter is an insulating paper configured to wrap the coil.

18. The motor of claim 16, wherein the gutter comprises:
a plurality of holes formed in an upper portion of the gutter.

19. The motor of claim 11, wherein the stator core is a laminated core in which a plurality of electrical steel plates is laminated, and
the flow path is provided by at least two electrical steel plates having different sectional shapes among the plurality of the electrical steel plates.

20. A vehicle comprising:
a motor including a stator and a rotor configure to rotate relative to the stator,
wherein the stator includes a stator core and a coil, and
wherein the stator core includes:
teeth, wherein the coil is wound around the teeth;
a plurality of slots partitioned by the teeth; and
a flow path configured to communicate with the plurality of slots from an outer circumference of the stator core through the stator core and allow oil to be supplied therethrough.
